(19) United States
(12) Patent Application Publication
(10) Pub. No.: US 2022/0279990 A1
(43) Pub. Date: Sep. 8, 2022

(54) Box for dispensing pre-cut wiping material which can be unwound in a strip, and use of such a dispensing box

(71) Applicant: Maurice Granger, ALBUFEIRA (PT)

(72) Inventor: Maurice Granger, ALBUFEIRA (PT)

(21) Appl. No.: 17/638,049

(22) PCT Filed: May 28, 2020
(86) PCT No.: PCT/FR2020/050908

§ 371 Date: Feb. 24, 2022

(30) Foreign Application Priority Data
Aug. 30, 2019 (FR) FR1909541

(51) Int. Cl. A47K 10/38; A47K 10/36

(52) U.S. Cl. CPC A47K 10/3827; A47K 10/3643

(57) ABSTRACT

A box for dispensing pre-cut wiping material. The box includes: a body delimiting a space for receiving the wiping material, which can be unwound in a strip on a front side of the body; a lid hinged on a rear side of the body; and a roller which is pivotably mounted on the front side of the body, which includes at least two sections of different diameters, including a first diameter and a second diameter smaller than the first diameter, and which is provided to support the strip with the lid mounted thereon. The sections of different diameters are configured to pull the strip with a speed differential, so as to tear the strip at a pre-cut line, when a user pulls on the strip from the front side of the body.

### TECHNICAL FIELD

The present invention relates to a box for dispensing pre-cut wiping material which can be unwound in a strip, in particular non-woven material.

The invention also relates to the use of such a dispensing box.

The field of the invention is that of devices for dispensing wiping material of the type hand towel, paper towel, toilet paper or the like. Conventionally, the material can be paper, cellulose wadding, non-woven fabric, or any other material adapted for the intended application.

The material can be positioned in the device in the shape of a spool. A strip of material is unwound from the spool, then guided out of the device so that it is accessible to a user.

Alternatively, the material can be positioned in the device as a block consisting of a strip folded alternately back and forth. The strip is unfolded and guided outwardly of the device so that it is accessible to a user.

### PRIOR ART

The Applicant has already designed numerous devices, as described for example in documents FR2960760, FR2966034, FR2986957, FR2992542 and FR2995520.

Today, manufacturers are seeking to reduce the complexity and cost of manufacturing devices. Indeed, devices comprising many parts and/or electronic systems see their attractiveness decline.

### DISCLOSURE OF THE INVENTION

The purpose of the present invention is to improve the existing devices.

Furthermore, the invention aims at providing a versatile device capable of cutting all types of pre-cut materials, even the most resistant, such as non-woven materials.

To this end, the invention relates to a box for dispensing pre-cut wiping material, the box comprising:
a body delimiting a space for receiving the wiping material, which can be unwound in a strip on a front side of the body;
a cover hinged on a rear side of the body; and
a roll which is pivotally mounted on the front side of the body, which comprises at least two sections of different diameters, including a first diameter and a second diameter smaller than the first diameter, and which is provided to bearingly receive the strip surmounted by the cover;
   the sections of different diameters being configured to drive the strip with a speed differential, so as to tear the strip at a pre-cut line, when a user pulls the strip from the front side of the housing.

Thus, the invention allows to provide a dispensing box having a simple construction, a reduced manufacturing cost, and high reliability. The invention is effective for cutting all types of pre-cut materials.

According to other advantageous features of the invention, taken alone or in combination:
The roll comprises at least one conical portion extending between the section of first diameter and the section of second diameter.
The sections comprise a central section of first diameter and two side sections of second diameter.
The roll comprises two conical portions each extending between the central section of first diameter and one of the side sections of second diameter.
The second diameter is a locally minimal diameter of the roll.
The roll is a part of revolution.
The roll has an outer surface made of elastomeric material.
The roll includes an elastomer ring defining the section of first diameter.
The roll includes an elastomer ring defining the section of second diameter.
The cover has a lower profile matching the outer profile of the roll, to press the strip onto the roll at each of the sections of different diameters.
The box comprises only three distinct elements, namely the body, the cover and the roll.

Another object of the invention is the use of a dispensing box as mentioned above, equipped with wiping material which can be unwound in a strip, characterised in that when a user pulls on the strip from the front side of the body, the sections of different diameters drive the strip at a speed differential, and the strip tears at a pre-cut line.

### BRIEF DESCRIPTION OF THE DRAWINGS

The invention will be better understood upon reading the description which follows, given only by way of non-limiting example and made with reference to the appended drawings wherein:

FIG. 1 is a perspective side view of a dispensing box according to the invention, equipped with a spool of wiping material which can be unwound in a strip.

FIG. 2 is a view similar to FIG. 1, without the spool.

FIG. 3 is a perspective front and bottom view of the box equipped with the spool.

FIG. 4 is a perspective rear view of the box equipped with the spool and without a rear wall.

FIG. 5 is a view similar to FIG. 3, without the spool.

FIG. 6 is a view similar to FIG. 5, with the cover raised.

FIG. 7 is a front view of the roll equipping the box.

### DETAILED DESCRIPTION OF THE INVENTION

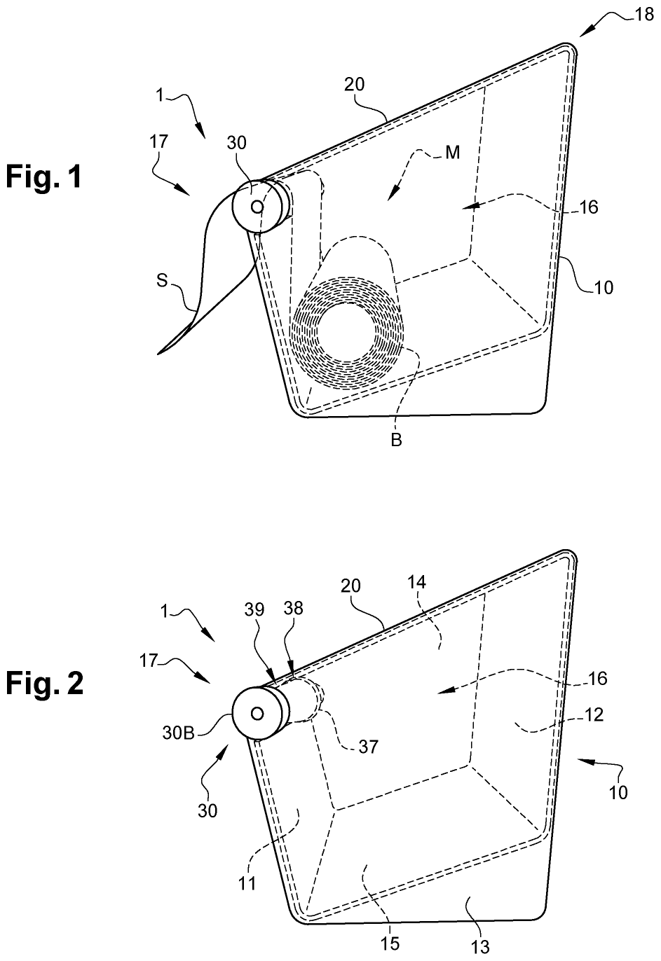

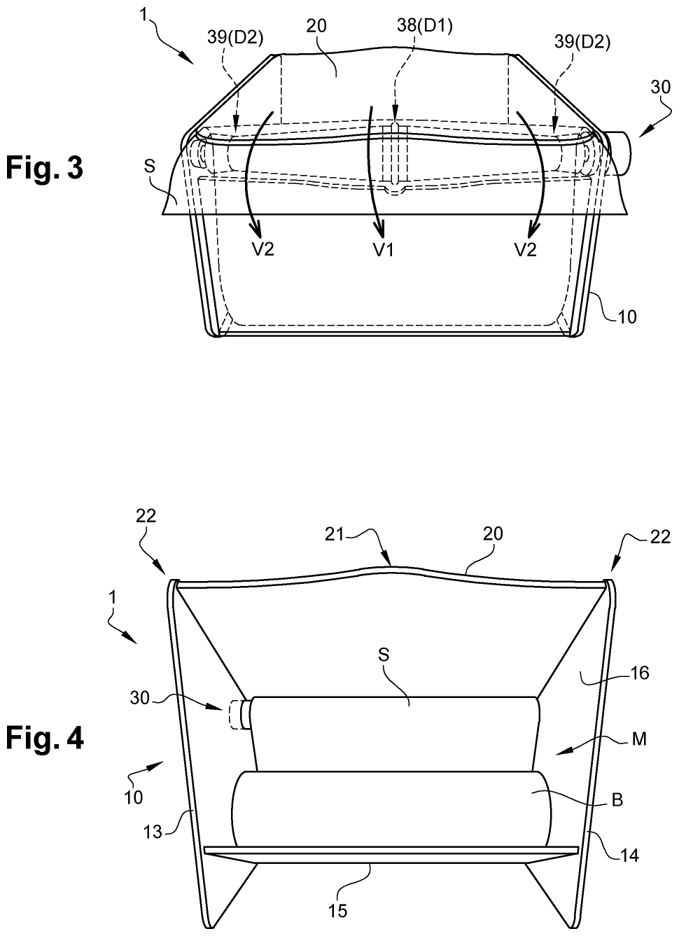

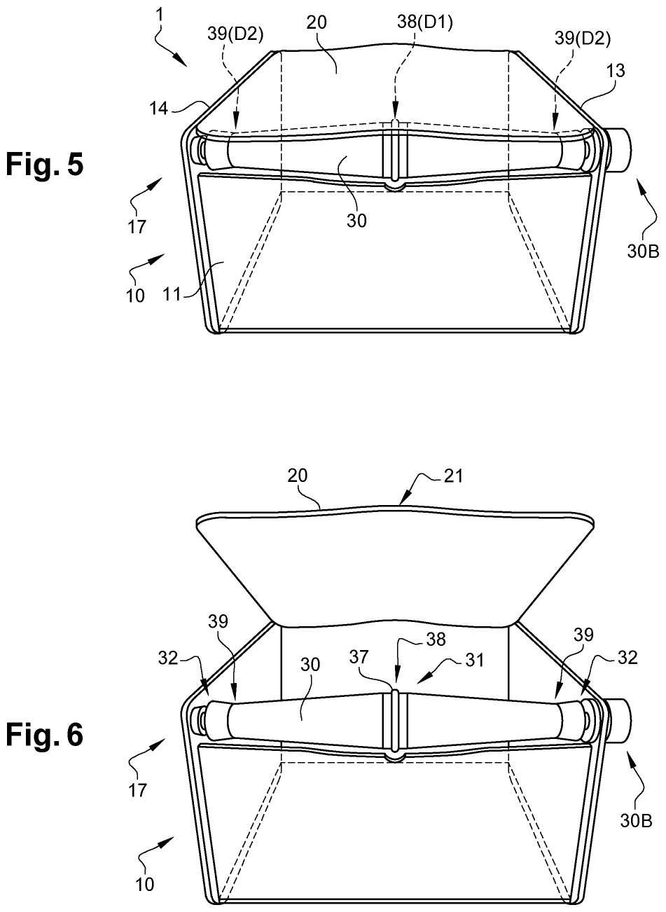

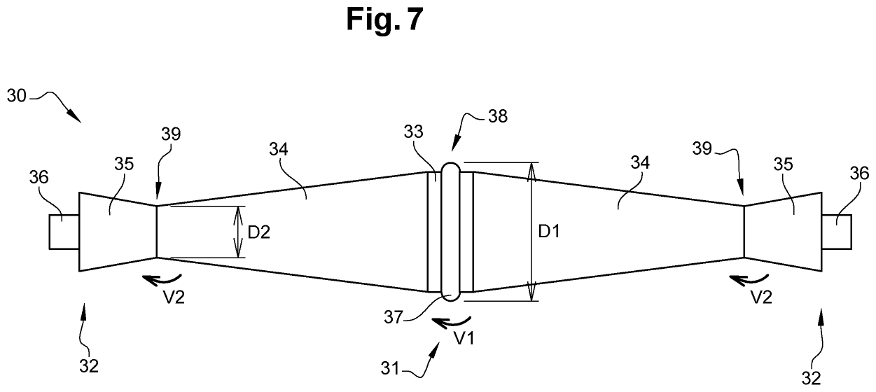

In FIGS. 1 to 7 is shown a dispensing box (1) according to the invention, designed to receive a wiping material (M) which can be unwound in a strip (S). The wiping material (M) is pre-cut, that is to say the strip (S) includes pre-cut lines. These lines constitute localised weakening areas, making it easier to cut the strip (S) into separate sheets.

The box (1) comprises a body (10), a cover (20), and a roll (30) for guiding the strip (S). With its reduced number of parts, the box (1) is simple, practical, economic and ecological.

The body (10) consists of five fixed walls (11, 12, 13, 14, 15) delimiting an interior space (16) for receiving the wiping material (M), in the shape of a spool (B) or a block. The body (10) includes a front wall (11), a rear wall (12), two side walls (13, 14) and a bottom wall (15). Advantageously, some or all of the fixed walls (11-15) can be constituted by a flat plate, so as to simplify the construction of the body (10) and reduce its manufacturing cost. Preferably, the body (10) is made of plastic material. The rear wall (12) can be provided with a system for attachment to a vertical support, such as a wall or a piece of furniture. The side walls (13, 14) can be shaped to serve as feet for the body (10), to place the box (1) on a horizontal support, when the box (1) is not attached to the vertical support, or when the rear wall (12) has no attachment system. The material (M) is which can be unwound in a strip (S) on a front side (17) of the body (10), between the cover (20) and the roll (30), above the front wall (11).

The cover (20) consists of a slightly domed plate in the central part (21). The cover (20) is hinged on a rear side (18) of the body (10), on the side walls (13, 14), above the rear wall (15). Preferably, the cover (20) is made of plastic material. Alternatively, the cover (20) can be made of metal or incorporate a metal portion, to adjust the pressure exerted on the strip (S) and the roll (30).

The roll (30) is pivotally mounted on the body (10) on the front side (17). The roll (30) guides the strip (S) from the spool (B) to the outside of the box (1) and the user. The roll (30) is a part of revolution. Preferably, the roll (30) is made of plastic material, with an outer surface made of elastomeric material provided to receive the strip (S).

The roll (30) comprises a central part (31) and two ends (32) mounted in pivoting connection on the side walls (13, 14) of the body (10). The central portion (31) comprises a cylindrical portion (33) and an elastomeric ring (37). On each side of the central part (31), the roll (30) comprises a conical portion (34) with a diameter decreasing towards the end (32), a conical portion (35) with a diameter increasing towards the end (32), and a side stud (36). For example, the conical portion (34) has a slope of 8°, while the conical portion (35) has a slope of 7°, relative to the central axis.

One of the studs (36) is housed in the wall (14), while the other stud (36) is housed in a button (30B) mounted on the wall (13). The button 30B is a safety button with non-return freewheel. The button 30B prevents the strip (S) from being withdrawn inwards and, by rotating, allows the strip (S) to stick out, in case there is little sticking out. This prevents the device from breaking down.

The ring (37) defines a central section (38) of maximum diameter (D1). Between the conical portions (34, 35), the roll (30) includes two side sections (39) of locally minimum diameter (D2). The diameter (D1) is greater than the diameter (D2). For example, the diameter (D1) is equal to 50 mm, while the diameter (D2) is equal to 20 mm. Preferably, the diameter (D1) is greater than or equal to twice the diameter (D2).

The box (1) is designed to cut the strip (S) pulled manually by a user. The sections (38, 39) are provided to bearingly receive the strip (S) surmounted by the cover (20). The roll (30) has three contacts on the strip (S), at the three sections (38, 39).

When a user pulls the strip (S) on the front side (17) of the body (10), the strip (S) rotates the roll (30) about its central axis. In reaction, the sections (38, 39) of different diameters (D1, D2) drive the strip (S) with a speed differential (V1, V2) therebetween. The upper section (38) of diameter (D1) drives the strip (S) with maximum speed (V1), while the sections (39) of lower diameter (D2) drive the strip (S) with a minimum speed (V2).

The invention thus allows to tear the strip (S) at a pre-cut line, starting at the central part (31). The speed differential (V1, V2) separates the formats by stretching. Another advantage is the exit dimension of the strip (S) for the grip.

Preferably, the cover (20) has a lower profile matching the outer profile of the roll (30), to press the strip (S) onto the roll (30) at each of the sections (38, 39) of different diameters (D1, D2). The weight and shape of the cover (20) can be adapted to adjust the pressure exerted on the strip (20) and the roll (30).

Moreover, the box (1) can be shaped differently from FIGS. 1 to 7 without departing from the scope of the invention, which is defined by the claims.

According to a variant not shown, the roll (30) can have only two contacts. For example, the roll (30) includes a section (38) of diameter (D1) disposed on a first side, and a section of diameter (D2) smaller than the diameter (D1) disposed on a second side. The roll (30) may include a frustoconical portion (34) between the two sections (38, 39). The sections (38, 39) of different diameters (D1, D2) drive the strip (S) with a speed differential (V1, V2) therebetween, so as to tear the strip (S) at a pre-cut line, starting at the section (38) of larger diameter.

Furthermore, the technical features of the various embodiments and variants mentioned above may be, in whole or for some of them, combined with each other. Thus, the box (1) can be adapted in terms of cost, functionality and performance.

1. A box for dispensing pre-cut wiping material, the box comprising:
a body delimiting a space for receiving the wiping material, which can be unwound in a strip on a front side of the body;
a cover hinged on a rear side of the body; and
a roll which is pivotally mounted on the front side of the body, which comprises at least two sections of different diameters, including a first diameter and a second diameter smaller than the first diameter, and which is provided to bearingly receive the strip surmounted by the cover;
the sections of different diameters being configured to drive the strip with a speed differential, so as to tear the strip at a pre-cut line, when a user pulls the strip from the front side of the body.

2. The box according to claim 1, wherein the roll comprises at least one conical portion extending between the section of first diameter and the section of second diameter.

3. The box according to claim 1, wherein the sections comprise a central section having a first diameter and two side sections having a second diameter smaller than the first diameter.

4. The box according to claim 3, wherein the roll comprises two conical portions each extending between the central section of first diameter and one of the side sections of second diameter.

5. The box according to claim 1, wherein the roll is a part of revolution.

6. The box according to claim 1, wherein the roll has an outer surface made of elastomeric material.

7. The box according to claim 1, wherein the roll includes an elastomer ring defining the section of first diameter.

8. The box according to claim 1, wherein the cover has a lower profile matching the outer profile of the roll, to press the strip onto the roll at each of the sections of different diameters.

9. The box according to claim 1, wherein the box comprises only three distinct elements, namely the body, the cover and the roll.

10. A method comprising:
using a dispensing box for dispensing pre-cut wiping material, the box comprising:
a body delimiting a space containing the wiping material, which can be unwound in a strip on a front side of the body;
a cover hinged on a rear side of the body; and
a roll which is pivotally mounted on the front side of the body, which comprises at least two sections of different diameters, including a first diameter and a second diameter smaller than the first diameter, and which is provided to bearingly receive the strip surmounted by the cover;
the sections of different diameters being configured to drive the strip with a speed differential;
pulling the strip from the front side of the body to unwind the strip, the sections of different diameters driving the strip with a speed differential such that the strip tears at a pre-cut line.
